(19) United States
(12) Patent Application Publication
(10) Pub. No.: US 2012/0028624 A1
(43) Pub. Date: Feb. 2, 2012

(54) SYSTEM AND METHOD FOR IMPROVING MOBILE DEVICE SAFETY BY SELECTIVELY DISABLING DEVICE FEATURES DURING UNSAFE OPERATIONAL CONDITIONS

(75) Inventors: Maya P. Jedlicka, Dallas, TX (US); Chris Maher, Melissa, TX (US); Terry Maher, Melissa, TX (US)

(73) Assignee: TCMD Holdings, LLC, Melissa, TX (US)

(21) Appl. No.: 12/847,113

(22) Filed: Jul. 30, 2010

(51) Int. Cl. H04M 3/00

(52) U.S. Cl. 455/418

(57) ABSTRACT

A system for improving safe operation of mobile communication devices includes an operational module installable on a mobile communication device. The mobile communication device is able to communicate wirelessly over a mobile communications network and has a plurality of internal sensors, a plurality of external sensors, a user interface, and a plurality of communications modules. The operational module is able to monitor at least one of the internal sensors and the external sensors, to determine whether the mobile communication device state is one of a plurality of predetermined device states. The predetermined device states represent predetermined watch list operations, which are determined based on improving the safe operation of the mobile communication device. The operational module executes predetermined operations in the event the mobile communication device state is one of the plurality of predetermined device states, which include controlling operation of the user interface and at least one of the plurality of communications modules.

### TECHNICAL FIELD

The present invention relates generally to the field of mobile telephony and mobile computer networking and, more particularly, to a system and method for improving mobile device operational safety.

### BACKGROUND

Modern communications systems are increasingly oriented toward highly mobile device usage. The earliest telephone systems, for example, required the user to sit or stand next to a handset that was fixed in a specific location. Improvements in fixed handset technology, such as longer telephone cords, for example, allowed users more freedom of movement, but nevertheless tethered the user to that fixed location.

Cordless telephones were developed to ease the inconvenience of fixed location technology, but still required a user to stay within a relatively small radius from the base station. Additionally, walls and other obstructions tended to attenuate cordless telephone signals, especially in earlier systems. Still, users appreciated the cordless telephone for its ability to allow the user to perform other tasks while participating in a telephone conversation. With the advent of cordless telephones, private home users could continue to complete chores throughout the home, for example.

Cellular (or mobile) telephones advanced cordless technology tremendously. Whereas a cordless telephone handset was strictly associated to its base station, mobile telephones could communicate with any properly configured cellular tower. Coverage areas soon brought mobile telephone access to a large percentage of the locations typical users would regularly visit. Further, the cost of mobile telephone devices fell to a point where such devices are now a common feature of modern communication.

Additionally, modern mobile communication devices are typically configured to perform many more tasks and operations than just simple telephone calls. Typical mobile communication devices now serve as small mobile computing environments, often complete with word processing and productivity software in addition to music and other media players, and a number of new communication methods previously unavailable to the typical user.

For example, many modern mobile communication devices can be configured to send and receive “text messages”, which are often sent using the “Short Message Service (SMS)” protocol. Similarly, many modern mobile communication devices can also be configured to send and receive “electronic mail” in the same or similar format using typical Post Office Protocol (POP) and Simple Mail Transfer Protocol (SMTP) protocols. Together with advanced telephone features, such as voice mail, call forwarding, etc., a typical mobile communication device offers users a means to connect with other users as never before in human history.

But as the ease of mobile communications has improved, users have begun to take for granted the complexity of these devices and the attention required to operate these mobile communication devices safely. In addition to other unsafe behavior, many users place themselves and others in danger of physical harm by operating a mobile communication device while also operating a motor vehicle. A perceived sharp increase in motor (and other) vehicle accidents and near-collisions has prompted many users to demand government restrictions on the operation of mobile communication devices while driving.

However, while some governmental entities have enacted laws prohibiting certain mobile device usage, such as operating a mobile telephone while driving through a school zone, for example, such regulation is often ineffective in modifying user behavior. Notwithstanding the ethical and moral problems associated with governmental regulation of private behavior, such government intervention typically cause unintended consequences that exacerbate the very problem the intervention was intended to solve.

Further, even where governmental intervention has tended to curb some undesirable user behavior, certain user groups are still vulnerable to a wide range of unsafe behavior. Young adults and teenagers, for example, are particularly likely to engage in unsafe mobile communication device usage. With limited driving experience, the challenge of operating both a motor vehicle and a mobile telephone is particularly difficult for young adults and teenagers. Parental supervision can help to reduce unsafe behavior, but does not completely eliminate the problem. As such, there are still a number of mobile communication device users engaging in unsafe device usage, which increases the probability of injurious traffic and other accidents.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

In a general aspect of the invention, a system for improving safe operation of mobile communication devices includes an operational module installable on a mobile communication device. The mobile communication device is able to communicate wirelessly over a mobile communications network and has a plurality of internal sensors, a plurality of external sensors, a user interface, and a plurality of communications modules. The operational module is able to monitor at least one of the internal sensors and the external sensors, to determine whether the mobile communication device state is one of a plurality of predetermined device states. The predetermined device states represent predetermined watch list operations, which are determined based on improving the safe operation of the mobile communication device. The operational module executes predetermined operations in the event the mobile communication device state is one of the plurality of predetermined device states, which include controlling operation of the user interface and at least one of the plurality of communications modules.

In a preferred embodiment, one of the predetermined device states indicates that the mobile communications device is in motion at or above a predetermined speed. In another embodiment, one of the predetermined device states indicates that the mobile communications device is located within a school zone. In another embodiment, one of the predetermined device states indicates that the mobile communications device is in a motor vehicle that is being driven in a manner predetermined as dangerous.

In another preferred embodiment, one of the predetermined operations includes blocking text messaging and SMS applications from accessing the user interface. In another embodiment, one of the predetermined operations includes blocking the mobile communication device from accepting incoming telephone calls. In another embodiment, one of the predetermined operations includes blocking incoming the mobile communication device from accepting incoming text and SMS messages. In another embodiment, one of the predetermined operations includes transmitting a message to a server, requesting that the server block text and SMS messages destined for the mobile communication device. In another embodiment, one of the predetermined operations includes reporting the mobile device state to a control device. In another embodiment, one of the predetermined operations includes reporting the mobile device state to a law enforcement agency.

In still another preferred embodiment, the operational module further comprises a security module, the security module able to execute emergency override operations. In another embodiment, the emergency override operations are based on the mobile communication device state. In another embodiment, one of the emergency override operations includes reporting the mobile device state to a law enforcement agency.

In another general aspect of the invention, a method for improving safe operation of mobile communication devices includes running an operational module installed on a mobile communication device. The mobile communication device is able to communicate wirelessly over a mobile communications network and has a plurality of internal sensors, a plurality of external sensors, a user interface, and a plurality of communications modules. The operations module monitors at least one of the plurality of internal sensors and at least one of the plurality of external sensors, to determine whether the mobile communication device state is one of a plurality of predetermined device states. The predetermined device states represent predetermined watch list operations, which are determined based on improving the safe operation of the mobile communication device. The operations module executes at least one predetermined operation in the event the mobile communication device state is one of the plurality of predetermined device states, which includes controlling operation of the user interface and at least one of the plurality of communications modules.

In a preferred embodiment, one of the predetermined device states indicates that the mobile communication device is in operation during a predetermined time of day. In another embodiment, one of the predetermined device states indicates that the mobile communication device has received an electronic image; and one of the predetermined operations includes restricting the received electronic image to a password-protected storage location on the mobile communication device. In another embodiment, one of the predetermined operations includes blocking telephone calls based on a comparison of a caller ID of the telephone call with a list of restricted numbers.

In another general aspect of the invention, a computer program product for improving safe operation of mobile communication devices is stored on a computer usable storage medium having computer usable program code embodied thereon. The computer usable program code comprises computer usable program code configured to launch an operational module installed on a mobile communication device, the mobile communication device able to communicate wirelessly over a mobile communications network, the mobile communication device having a plurality of internal sensors, a plurality of external sensors, a user interface, and a plurality of communications modules. The computer usable program code also comprises computer usable program code configured to monitor at least one of the plurality of internal sensors and at least one of the plurality of external sensors, to determine whether the mobile communication device state is one of a plurality of predetermined device states, the predetermined device states representing predetermined watch list operations, the predetermined watch list operations being determined based on improving the safe operation of the mobile communications device. The computer usable program code also comprises computer usable program code configured to execute predetermined operations in the event the mobile communication device state is one of the plurality of predetermined device states. The predetermined operations include controlling operation of the user interface and at least one of the plurality of communications modules.

In a preferred embodiment, wherein one of the predetermined device states indicates that the mobile communication device has moved out of a predetermined geographic area. In another embodiment, one of the predetermined operations includes blocking Internet access to and from the mobile communication device.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing a high-level overview of a system for improving mobile device operational safety in accordance with a preferred embodiment;

FIG. 2 illustrates a block diagram showing a system for improving mobile device operational safety in accordance with a preferred embodiment;

FIG. 3 illustrates a block diagram showing a system for improving mobile device operational safety in accordance with another preferred embodiment;

FIG. 4 illustrates a block diagram showing a system for improving mobile device operational safety in accordance with another preferred embodiment;

FIG. 5 illustrates a high-level flow diagram depicting logical operational steps of a method for improving mobile device operational safety, which can be implemented in accordance with a preferred embodiment;

FIG. 6 illustrates a high-level flow diagram depicting logical operational steps of a method for improving mobile device operational safety, which can be implemented in accordance with a preferred embodiment;

FIG. 7 illustrates a block diagram showing a mobile communication device with improved operational safety in accordance with a preferred embodiment;

FIG. 8 illustrates a block diagram showing the operational module of FIG. 7, in accordance with a preferred embodiment;

FIG. 9 illustrates a block diagram showing the processing module of FIG. 8, in accordance with a preferred embodiment; and

FIG. 10 illustrates a block diagram showing the action module of FIG. 8, in accordance with a preferred embodiment.

### DETAILED DESCRIPTION

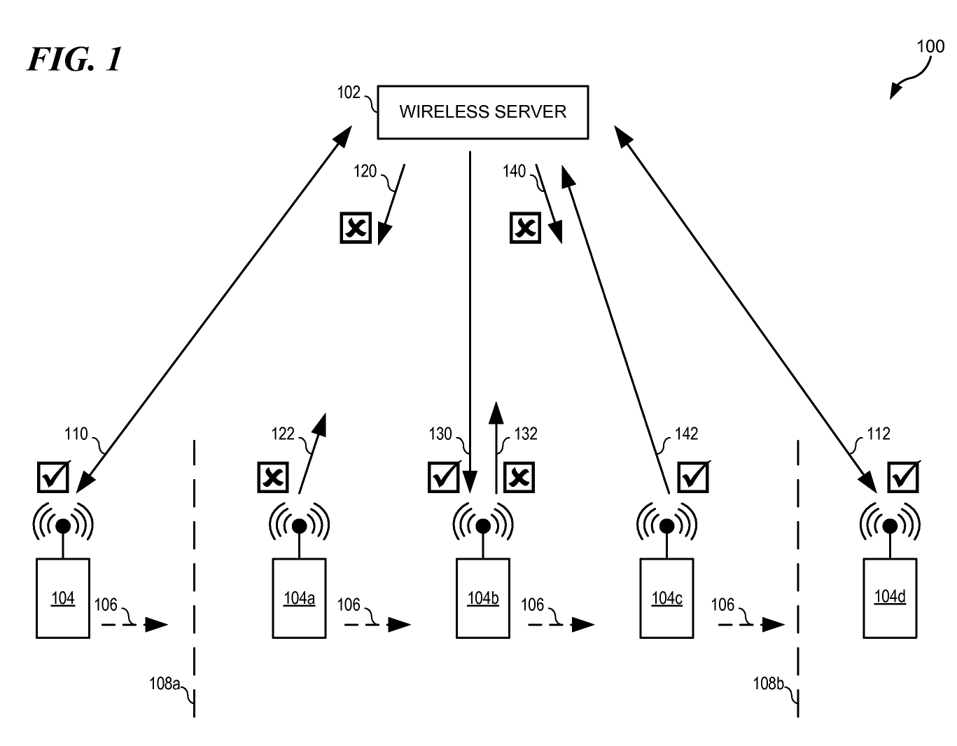

FIG. 1 is a high-level block diagram illustrating certain components of a system 100 for improved mobile communication device operational safety, in accordance with a preferred embodiment of the present invention. Very broadly, the present invention solves the problem of unsafe mobile communication device use by restricting access to or use of certain features, based on inputs that together indicate a predetermined unsafe environmental setting. Other embodiments provide additional control over the operation of the mobile communication device, based on predetermined factors, as described in more detail below. Generally, system 100 includes a wireless server 102 communicating with a mobile communication device handset 104.

As illustrated, handset 104 moves in the direction generally indicated by arrow 106, through a predetermined zone, delineated by boundaries 108a and 108b. In the illustrated embodiment, when handset 104 is located outside of the predetermined zone, handset 104 communicates normally with server 102, as indicated by arrow 110. Generally, the embodiments disclosed herein restrict operation of handset 104 within the boundaries of the predetermined zone, thereby improving the operational safety of handset 104, as described in more detail below. The particular handset 104 feature restricted, and the manner in which that feature is restricted, can vary between embodiments.

For example, in some embodiments, system 100 blocks communication of the restricted feature at both handset 104a and server 102, as shown by arrows 120 and 122. In some embodiments, system 100 blocks communication of the restricted feature at handset 104b, but not server 102, as shown by arrows 130 and 132. In some embodiments, system 100 blocks communication of the restricted feature at the server 102, but not handset 104c, as shown by arrows 140 and 142. In some embodiments, system 100 blocks access to or use of certain features of handset 104, as described in more detail below. As used herein, “communication of the restricted feature” is intended to be broad, and includes both transmissions to or from a device, and operations conducted on the device itself, that relate to or execute the restricted feature. As described in more detail below, the embodiments disclosed herein provide for improved operational safety in a wide variety of configurations.

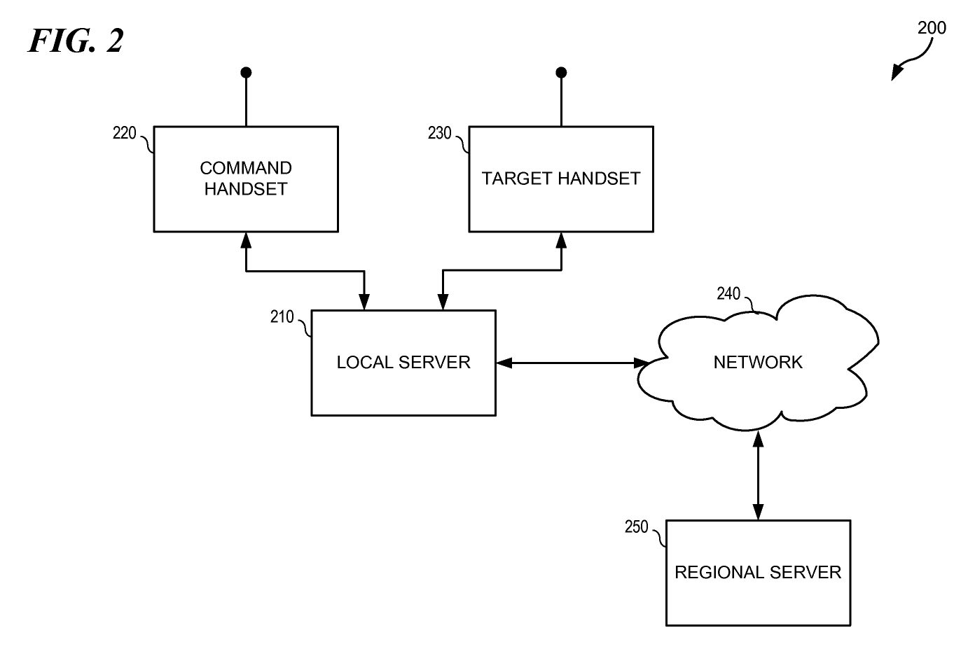

For example, FIG. 2 is a high-level block diagram illustrating certain components of a system 200 for improved mobile communication device operational safety, in accordance with a preferred embodiment of the present invention. Generally, system 200 improves operational safety of a mobile communication device by introducing a command handset that can pre-configure restrictions on a target handset, as described in more detail below. System 200 includes a local server 210.

In the illustrated embodiment, local server 210 is an otherwise conventional mobile communication device server. In one embodiment, local server 210 is a personal computer such as an IBM PC or an Apple computer, for example. In one embodiment, local server 210 is a more sophisticated server, such as a dedicated server employed in common business environments. As described in more detail below, local server 210 is configured to perform certain functions in order to provide improved mobile communication device safety. In one embodiment, a user operating local server 210 configures a mobile communication device for improved operational safety, as described in more detail below.

In the illustrated embodiment, a command handset 220 and a target handset 230 couple to local server 210. Both handset 220 and target handset 230 are otherwise conventional mobile communication devices, modified as described herein. Generally, in one embodiment, command handset 220 controls certain functions of local server 210 in order to make changes to target handset 230 that improve the operational safety of target handset 230.

For example, in one embodiment, command handset 220 presents a graphical user interface (GUI) to a user, and the user selects various options and configurations using the GUI. Based on this user input, command handset 220 passes commands and information to local server 210. In response to received commands and information, local server 210 issues commands and passes information to target handset 230.

Generally, commands and information passed and/or issued to target handset 230 occur during three broad phases of operation: installation, configuration, and operation. In the configuration phase, local server 210 configures the operational parameters and safety protocols that restrict operation of target handset 230, according to the commands and information received from command handset 220, as described in more detail below. In the operation phase, also described in more detail below, target handset 230 operates normally, except when otherwise restricted by installed control software.

During the installation phase, local server 210 installs control software on target handset 230 (and, in some embodiments, command handset 220). In one embodiment, once installed, the control software cannot be uninstalled or disabled from target handset 230. In one embodiment, to uninstall the control software, both command handset 220 and target handset 230 must be connected to local server 210. In an alternate embodiment, to uninstall the control software, the user must enter a pass code at command handset 220 and/or target handset 230.

In one embodiment, the installation phase requires an authorization code from the control software vendor and/or other outside source. As illustrated, local server couples to a network 240. Network 240 can be the Internet and/or any other suitable network. As illustrated, a regional server 250 couples to network 240. In one embodiment, a user enters a product key (or other identifying indicia) at command handset 220 (or local server 210) and the local server 210 passes the product key to regional server 250 via network 240. In one embodiment, regional server 250 verifies the product key as authentic, uncompromised, and/or properly purchased, or other suitable verification characteristic. If the product key is authentic, regional server 250 returns an activation code to local server 210. Local server 210 verifies the activation code and, if valid, installs the control software on target handset 230.

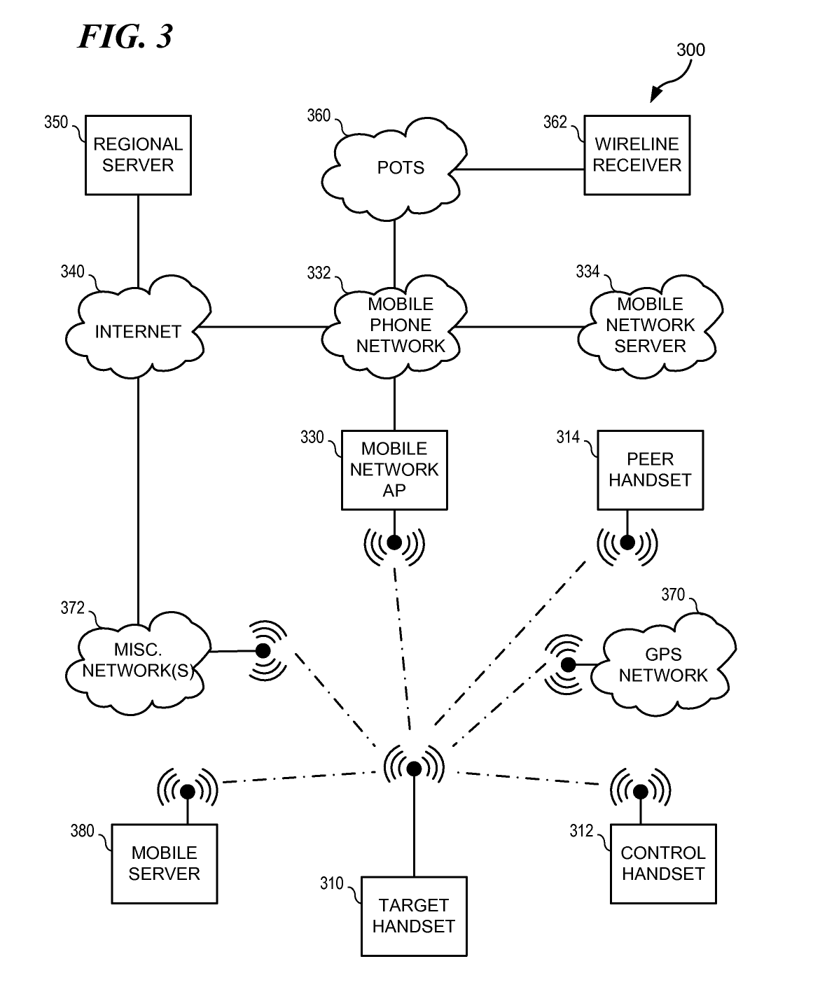

In one embodiment, as illustrated in FIG. 2, a user initiates installation and configuration of the control software through physical connections with the command and target handsets, coupled to a local server. In alternate embodiments, a user can install, initiate, configure, direct, and monitor the control software through a variety of network and/or wireless connections. FIG. 3 describes these alternate embodiments in more detail.

Specifically, FIG. 3 illustrates a system 300. System 300 includes a variety of exemplary components that can be configured to install, configure, and operate the control software, in accordance with a variety of embodiments. For example, in one embodiment, a target handset 310 and control handset 312 communicate wirelessly. Generally, target handset 310 and control handset 312 are, in one embodiment, both mobile communication devices. Thus, in one embodiment, control handset 312 can be configured to direct target handset 310 to install and configure control software. In one embodiment, command software installed on control handset 312 can be configured to prevent unauthorized handsets from issuing commands to target handset 310. For example, control handset 312 can be configured to prevent peer handset 314 from issuing commands to control software running on target handset 310.

In one embodiment, target handset 310 (in one embodiment, based on commands from control handset 312) requests installation and configuration of the control software by communicating with a server over an otherwise conventional mobile telephone network. For example, as illustrated, target handset 310 can be configured to communicate with mobile network access point (AP) 330. Generally, AP 330 is an otherwise conventional mobile telephone access point, which couples to an otherwise conventional mobile telephone network 332. For example, in one embodiment, AP 330 is a conventional code division multiple access (CDMA) cellular telephone tower.

In the illustrated embodiment network 332 couples to a mobile network server 334. Generally, server 334 performs a variety of functions, including functions that support embodiments disclosed herein and functions that support ordinary mobile telephone operations. In the illustrated embodiment, network 332 also couples to the Internet 340. In the illustrated embodiment, a regional server 350 also couples to the Internet 340.

As such, in one embodiment, control handset 312 and target handset 310 communicate with regional server 350 (via AP 330, network 332, and Internet 340). In one embodiment, in the configuration and operational phases, handsets 310 and 312 communicate with the regional server 350 to configure and restrict operations of target handset 310, as described in more detail below. In one embodiment, in the installation phase, handsets 310 and 312 communicate with the regional server to push the control software to handset 310 and/or to push the command software to handset 312. As described above, the installation phase can include verification of the right to install the control and/or command software by sending a product key or other indicia to regional server 350 and receiving an authorization indicia in return.

Thus, in one embodiment, a user can purchase a product key to enable installation of the command and/or control software. In one embodiment, a user of command handset 312 sends a text (or short message service (SMS)) message to a designated number (representing regional server 350, for example). In response, in one embodiment, the target handset 310 receives an installation activation code. In an alternate embodiment, in response to a text/SMS message containing a valid product key, system 300 installs the control software on target hand 310 and, in some embodiments, installs the command software on command handset 312. As described above, in one embodiment, a user operating target handset 310 cannot un-install or otherwise remove or disable the control software without authorization from the command handset 312 user.

In the illustrated embodiment mobile phone network 332 also couples to a “plain old telephone server” (POTS) network 360. Generally, POTS network 360 performs a variety of functions, including functions that support embodiments disclosed herein and functions that support ordinary telephone operations. For example, as shown, POTS network 360 couples to one or more wire line receivers 362. Generally, the embodiments disclosed herein work best in wireless environments. However, some of the disclosed embodiments can be configured to accommodate and/or support wire line features. For example, in some embodiments, system 300 blocks incoming telephone calls based, in part, on the telephone number from which the call originates, which in some cases is a landline. Additional details regarding the restriction features of various embodiments are described in more detail below.

In some embodiments, target handset 310 and/or control handset 312 can be configured to communicate with other networks. For example, in the illustrated embodiment, handsets 310 and 312 can also communicate with global positioning satellite (GPS) network 370, which is the conventional GPS network. Similarly, handsets 310 and 312 can also communicate with other miscellaneous networks 372, which couple to the Internet 340. As such, in some embodiments, handsets 310 and 312 can be configured to send and receive command, configuration, and control information to and from regional server 350 via a network 372.

In some embodiments, regional server 350 controls access to the installation of command and/or control software on handsets 310 and 312, with delivery of the software performed by other systems. For example, in the illustrated embodiment, handset 310 is in communication with a mobile server 380. In one embodiment, server 380 is configured to push control software to handset 310, in response to an authorization code received from regional server 350. In one embodiment, regional server 350 identifies the geographic location of handset 310 and/or 312 (by GPS network 370, in one embodiment), and selects a nearby mobile server 380 to deliver authorized software to handset 310 and/or 312.

Generally, mobile server 380 is configured as a server able to push software to a mobile communication device handset. In one embodiment, mobile server 380 can deliver software to a plurality of handsets 310 and/or 312, simultaneously. In one embodiment, server 380 is able to communicate via standard wireless protocols, including Bluetooth and IEEE 802.x protocols. In one embodiment, server 380 is a fixed AP of a network. In one embodiment, server 380 is itself a mobile communication device, such as a Smartphone, for example.

For example, in one embodiment, the command handset 312 user (or target handset 310 user) calls and/or sends a text message to a predetermined telephone number. The telephone number routes to a selected mobile server 380, which, in one embodiment, automatically responds with a text message configured to initiate installation upon user approval. For example, in one embodiment, the text message includes a clickable text prompt to accept the software installation. In one embodiment, in response to the user clicking the text prompt, mobile server 380 pushes the control software to target handset 310 (and/or command handset 312, in some embodiments).

Thus, as described above, the embodiments disclosed herein can be installed, configured, and operated in a variety of systems. As such, the embodiments disclosed herein improve device safety by improving the variety of options in installing, configuring, and operating the features disclosed. Additionally, the embodiments disclosed herein also offer extensive control over restriction of features on one or more target handsets, which improves operational safety and performance of both mobile communication devices and their users.

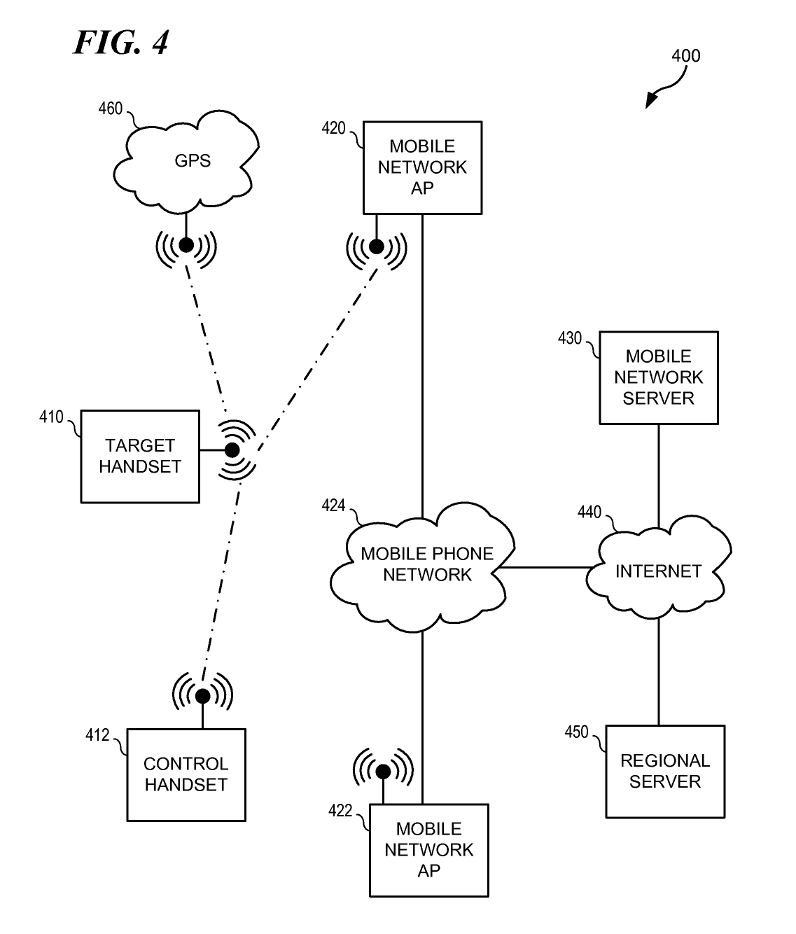

For example, FIG. 4 is a high-level block diagram illustrating a system 400 for improving mobile communication device safety. As shown, a target handset 410 is in communication with a control handset 412, a mobile network AP 420, and the GPS network 460. Generally, in operation, target handset 410, as a mobile communication device, is movable from geographic location to geographic location. As such, one skilled in the art will understand that handset 410 will often change access points to the mobile networks. In the illustrated embodiment, for example, target handset 410 is shown out of range of mobile network AP 422, which, along with AP 420, also couples to mobile phone network 424.

As described above, in one embodiment, mobile phone network 424 also couples to Internet 440. In the illustrated embodiment, a mobile network server 430 also couples to Internet 440. Similarly, in the illustrated embodiment, a regional server 450 also couples to Internet 440. As such, one or more features of the disclosed embodiments can be performed by server 430, server 450, or both. For example, in one embodiment, server 430 blocks text messages intended for target handset 410 and server 450 blocks access to pictures stored on target handset 410. Other combinations will be apparent to one skilled in the art, especially in light of the additional details described below.

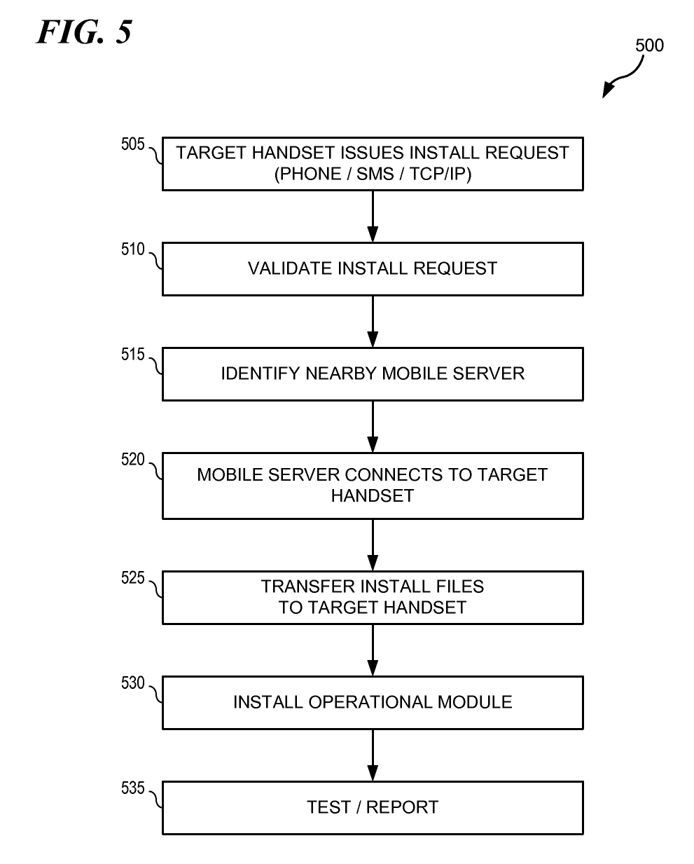

As described above, the disclosed embodiments can be configured to install command and/or control software from a mobile server. FIG. 5 is a flow diagram illustrating one such embodiment. The process begins at block 505 wherein the target handset issues an install request. In one embodiment, target handset 310 issues an install request to server 350, in response to a command from command handset 312. In one embodiment, command handset 312 issues an install request to server 350, on behalf of target handset 310. In one embodiment, the install request includes a product key.

Next, as indicated at block 510, regional server 350 validates the install request. In one embodiment, server 350 determines whether a received product key is valid and/or authentic. Next, as indicated at block 515, server 350 identifies a nearby mobile server. In one embodiment, server 350 identifies and selects a nearby mobile server 380 by reference to GPS data retrieved from GPS system 370.

Next, as indicated at block 520, the selected mobile server 380 connects to the target handset 310. In one embodiment, server 380 sends a confirmation text/SMS message to target handset 310. Next, as indicated at block 525, mobile server 380 transfers install files to target handset 310. In one embodiment, server 380 transfers files from server 380 directly to target handset 310. In an alternate embodiment, server 380 initiates transfer of the install files from regional server 350 to handset 310 via Internet 340.

Next, as indicated at block 530, target handset 310 installs control software using the received install files. Next, as indicated at block 535, target handset 310 tests the installation and sends a report to mobile server 380 and/or command handset 312 and the process ends. As described above, in one embodiment, target handset 310 cannot uninstall, remove, or disable installed control software without authorization from command handset 312 and/or regional server 350.

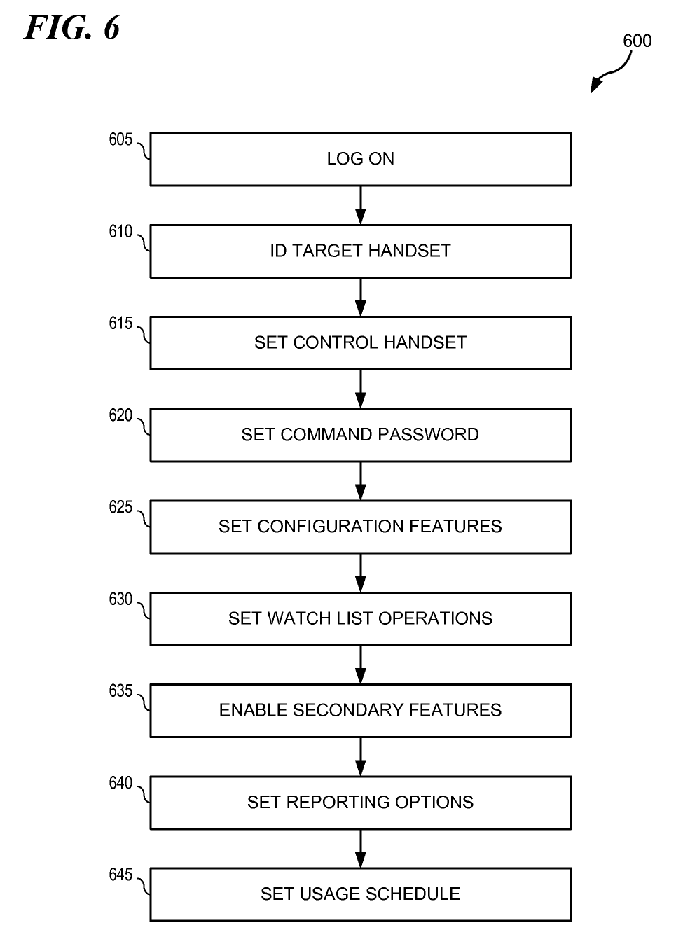

As described above, the disclosed embodiments can be configured to allow for mobile and/or remote administration of the command and/or control software running on the command handset and/or target handset. FIG. 6 is a flow diagram illustrating one such embodiment.

As indicated at block 605, a user logs on to a command site. In one embodiment, the command site is a website hosted on the Internet and/or a private network. In another embodiment, the command site is a GUI on a command handset 312. In another embodiment, the command site is a GUI on a local server 210. In one embodiment, the user logs on to the command site by providing a product key, pre-configured username/password, and/or a returning user username and password.

Next, as indicated at block 610, the user identifies the target handset. In one embodiment, the user provides a cellular telephone number identifying a target handset 310. Next, as indicated at block 615, the user sets the control handset for the identified target handset. In one embodiment, the user provides a cellular telephone number identifying a control handset 312. In one embodiment, the control handset 312 includes command software preconfigured to select that handset 312 as the control handset for the identified target handset.

Next, as indicated at block 620, the user sets a command password. Generally, in one embodiment, the command password protects all or part of the configuration features such that a user must provide the command password to change the protected features. In one embodiment, the user sets a command password that the control handset 312 user knows, and that the target handset 310 user does not know.

Next, as indicated at block 625, the user selects configuration features. Generally, configuration features are options that control the operation of the target device. For example, in one embodiment, configuration features include hours of allowable operation, geographic location and zone-based restrictions, device speed restrictions, device- or telephone-number-specific restrictions, etc. Additional examples are provided in more detail below. Configuration features form the basis for predetermined device states that trigger watch list operations.

Next, as indicated at block 630, the user selects watch list operations. Generally, watch list operations are predetermined operations the user wishes to execute in response to identified device states. As described above, the device states are based on the configuration features. For example, if the device state is “operating in a school zone” and the configuration feature disables operation in a school zone, the selected watch list operations execute.

The specific watch list operations to execute can be configured based on the nature of the configuration features, device state, and safety objectives. In the school zone example above, for example, watch list operations can include blocking incoming and outgoing text/SMS messages, blocking GUIs that read, manage, and/or generate text/SMS messages, blocking incoming and outgoing telephone calls, etc. Additional examples are provided in more detail below.

Next, as indicated at block 635, the user enables secondary features. In one embodiment, secondary features include user customization options, ring and alert tones, download and quarantine directories, automatic software updates, look and feel selections, etc. Additional examples are provided in more detail below. Next, as indicated at block 640, the user sets reporting options. For example, in one embodiment, reporting options include where to send reports, what reports to send, usage reports, alerts for incoming quarantined photographs or other material, etc.

Next, as indicated at block 645, the user sets the usage schedule. In one embodiment, the usage schedule includes times when the control software is operational. In another embodiment, the usage schedule includes times when certain features of the control software are enabled. For example, in one embodiment, the usage schedule indicates that incoming telephone calls are blocked from 11 PM to 7 AM, monitored for particular usage scenarios (e.g., unsafe operation) from 7 AM to 6 PM, and are otherwise unrestricted from 6 PM to 11 PM.

Thus, system 200, 300, and 400, can be configured to restrict certain features and/or operations of a target handset based on a wide variety of configuration options. The particular configuration options and watch list operations can be customized to the typical usage of the target handset. For example, a target handset operated by a teenage school child can be expected to endure different operational environments than a target handset operated by an adult employee working as a delivery driver. The embodiments disclosed herein can be configured to provide improvements in the operational safety of both the target handset and its user that account for the expected usage of the device.

For example, generally, typical device usage can be divided roughly into two categories: personal and business use. The embodiments disclosed herein can be configured to provide a wide variety of features improving safety in personal-type use of a mobile communication device. For illustrative purposes, consider a control handset 312 operated by the parents of a dependent child, where the dependent child operates a target handset 310. For example, a “clock control” feature in one embodiment allows parents (i.e., the control handset users) to disable texting during certain hours. As described above, in one embodiment, parents can set password-protected controls on the target handset from either an Internet-based website or a control handset.

Additionally, in some embodiments, all features are password protected so that the control software on the target handset cannot be uninstalled or altered without parental permission. In one embodiment, if a password is entered incorrectly more than three times, the control software sends a password alert to the parents.

Additionally, in some embodiments, a “speed control” feature restricts operations based on the speed at which the target handset is travelling. For example, in one embodiment, parents set a certain speed (e.g. 65 mph). If the speed is exceeded, indicating that the target handset is probably in a motor vehicle travelling above 65 mps, the control software, in one embodiment, sends a text and/or SMS message to the parents. In an alternate embodiment, the control software includes information identifying the motor vehicle speed limit at the geographical location of the target handset. In one embodiment, the parents can set an “exceeding limit” (e.g., 5 mph). If the target handset speed exceeds the set limit above the motor vehicle speed limit, in one embodiment, the control software sends an electronic map of the location and the actual speed to the parent.

In one embodiment, the control software sends speed updates by text/SMS message every X seconds or minutes (as determined by the parents) until the speed is once again within acceptable limits. In one embodiment, the control software sends alerts to the parents if the target handset is subject to environmental conditions that indicate unsafe driving. For example, in one embodiment, the control software sends alerts to the control handset if the target handset is subject to quick accelerations, sudden right/left movements, and/or sudden stops.

Additionally, in some embodiments, a “zone and perimeter control” feature allows parents to set allowable usage zones based on geographic location of the target handset. For example, in one embodiment, the parents set tracking zones, such as the child's school or home. If the target handset leaves the set zones, the control software sends an alert to the parents' command handset or other device. In one embodiment, the control software disables one or more features (e.g., sending/receiving text messages) while the target handset is located within a set zone (e.g., the child's school).

Additionally, in some embodiments, a “call control” feature can restrict telephone calls based on set configuration options. For example, the parents can set times where the control software logs incoming and/or outgoing phone calls, and generates a report that the control software sends to the control handset. For example, in one embodiment, when a call goes out from the child's phone (i.e., the target handset) after 11 PM, the control software sends a text message to the parent's phone (i.e., the control handset). In one embodiment, parents can also configured the control software to block certain telephone and/or text/SMS numbers from sending/receiving telephone calls and/or text/SMS messages.

Additionally, in some embodiments, a “photo control” feature can restrict receipt and/or display of photographs on the target handset. For example, in one embodiment, the control software moves any photograph received by the target handset into a password-protected photo gallery. In one embodiment, the parents can then review their child's downloaded photos and delete or save photographs based on the parents' judgment.

Additionally, in some embodiments, a “usage reporting” feature compiles selected data for reporting to the parents. For example, in one embodiment, parents can check daily or weekly reports to see usage data for the target handset, including, the number of texts sent, number of texts received, incoming/outgoing calls, total call duration, etc. Thus, in one embodiment, the usage reporting feature allows parents to monitor the amount of time children are spending on texts and phone calls.

Thus, the embodiments described herein can be configured to provide a wide variety of features to improve control over target handset personal-type usage and, therefore, to improve the operational safety of the target handset and its user. As described above, the embodiments disclosed herein can also be configured to provide a wide variety of features improving safety in business-type use of a mobile communication device.

For example, consider a control handset 312 operated by a supervisor in a business where one or more employees operates a target handset 310. In some embodiments, the control software tracks each employee as he operates a motor vehicle. Thus, in one embodiment, business that operate motor vehicles, such as truckers, bus drivers, cab drivers, train operators, and other such businesses, can monitor the operation of their drivers without having to install expensive equipment limited to the business vehicles.

For example, in one embodiment, the control software monitors the speed and location of the target handset, which can provide the information necessary to provide reports and alerts to the business. For example, in one embodiment, the control software sends alerts to the supervisor when the state of the employee's target handset indicates erratic driving, excess speed, and/or insufficient speed (indicating the driver is not actually performing his tasks).

In another embodiment, management features allow the supervisor to configure the target handset to assist in employee supervision. For example, in one embodiment, the control software records a “clock-in time” as the time the employee sends a text message indicating that the employee is beginning her work. In one embodiment, the clock-in message can also be configured to launch other features of the control software. For example, in one embodiment, the control software maintains a call log recording the time/date and telephone number of all incoming and outgoing telephone calls, beginning when the employee sends the clock-in message and ending when the employee sends a “clock-out” message.

In some embodiments, the configuration options provide a variety of options for restricting one or more features and/or operations of the target handset. For example, in one embodiment, the configuration features include all of the above-described options relating to personal-type mobile communication device operation. In one embodiment, the supervisor can configure the control software (through the configuration options) to restrict all text/SMS functionality, all Internet connectivity, block all incoming and/or outgoing calls except for emergency (i.e., 911) dialing, or other restrictions. As described above, the supervisor can set time periods when the restrictions are active, such as during normal business hours, for example. Similarly, the supervisor can set geographical locations or zones where the restrictions are active, such as when the target handset is on company property, for example.

Additionally, some embodiments offer a variety of reporting options. For example, in one embodiment, the supervisor can receive alerts at a control site such as a webpage. In one embodiment, some embodiments include a web portal accessible from the Internet, through which the supervisor can monitor the location, device state, and alerts for one or more (or all) of the target handsets of the business. Additionally, in some embodiments, the supervisor can print reports in a variety of formats, highlighting specified information (e.g., number of text messages, average length of telephone calls, etc.), by employee (i.e., by the employee's target handset).

Thus, generally, the disclosed embodiments can be configured to push control software to a target mobile communication device that can control text messaging, phone usage, internet browsing, email usage, and/or other operations of the target device. As described above, various embodiments provide the ability to configure and modify controls centrally, via a server, via a control handset, and via text/SMS messages. Additionally, some of the disclosed embodiments provide the ability to track and report which target handsets are configured with control software, how that software is configured, and how and in what environments that target handset is being used.

Additionally, in some embodiments, the supervisor can access a centralized control server, such as server 350, for example. In some embodiments, the control server provides the ability to enter or import a list of phone numbers to control, an interface to a company directory (e.g., Active Directory), automated software push for installation, automated software push for future releases, automated push of all rules, and other suitable options.

Additionally, in some embodiments, the control server can be configured to receive and execute text and/or SMS message commands from a control handset. Additionally, in some embodiments, the control server can be configured with a security module. In some embodiments, the security module can be configured to provide defined users, security groups within groups, company organization rules, the ability to assign administrative rights by organizational department, and rules by group, as well as other suitable features.

Additionally, in some embodiments, the control software can be configured to provide highly granular control over one or more target handsets based on the individual user, groups of users, and/or types of users. For example, in some embodiments, the control software can be configured to block inbound and/or outbound text/SMS messages and/or telephone calls, except from identified numbers controlled by the centralized command server, allow/block electronic mail, allow/block web browsing software, and store blocked text/SMS messages for subsequent display (when no longer blocked) and stored voicemail for subsequent playback (when no longer blocked).

Similarly, in some embodiments, the control software can be configured to allow/block features based on calendar and timer, location, geographical zones and other suitable conditions and device states. Similarly, the control software can be configured to provide the ability of the supervisor to remove all restrictions, completely disable the device, locate the device, and/or perform other suitable operations.

Additionally, in some embodiments, the control server can be configured to report any attempts to disable the control software (whether successful in whole or part), provide audit reporting of the target handsets that have and have not performed particular upgrades, and management reporting by group, security levels, etc. As such, the disclosed embodiments can be configured to provide a significant amount of control over the operation of one or more mobile communication devices.

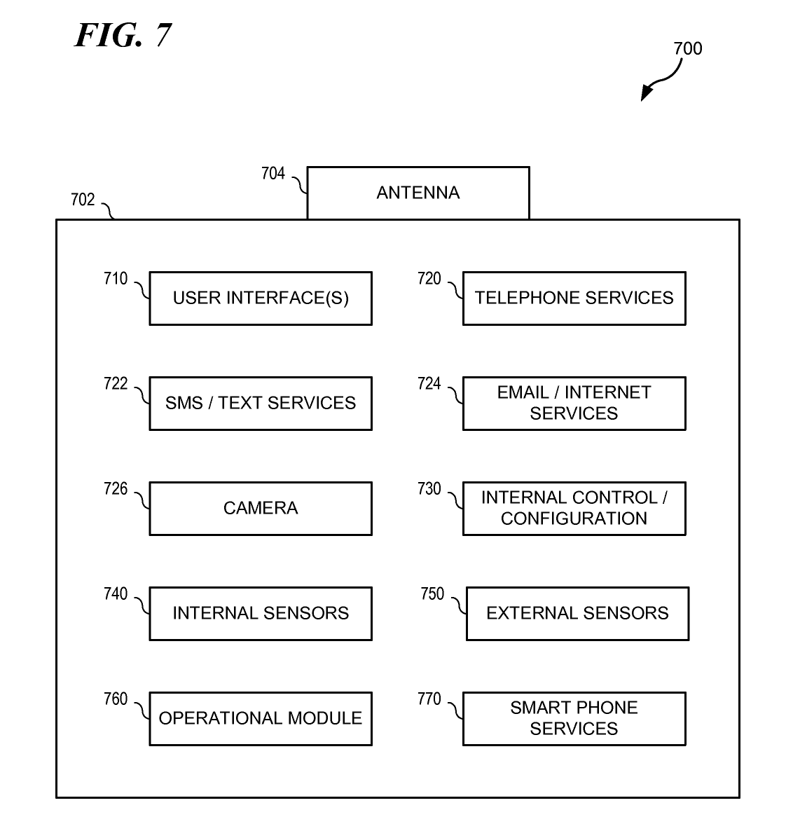

Generally, such mobile communication devices can be any suitable communication device, configured as described herein. FIG. 7 illustrates a high-level block diagram of one such device, mobile communication device 700. In the illustrated embodiment, device 700 includes a body 702 which couples to an otherwise conventional antenna 704. In the illustrated embodiment, body 702 includes a variety of components, provided as illustrative of otherwise conventional mobile communication devices.

For example, device 700 includes a user interface 710, which is generally configured to receive user input and display information to the user, which in one embodiment includes sounds. Similarly, device 700 includes telephone services module 720, which is configured to provide mobile telephone services for device 700. Similarly, device 700 includes SMS/text services module 722, which is configured to provide conventional text and SMS message services. Similarly, device 700 includes email/internet services module 724, which is configured to provide conventional electronic mail and internet services. Similarly, device 700 includes camera module 726, which is configured to provide conventional mobile device photography services.

Similarly, device 700 includes internal control/configuration module 730, which is configured to provide mechanisms for the user of device 700 to set the various options common to mobile communication devices. Device 700 also includes internal sensors 740 and external sensors 750. Generally, in one embodiment, internal sensors 740 monitor device states internal to device 700, such as which software application the user is operating and other suitable states, for example. Generally, in one embodiment, external sensors 750 monitor device states external to device 700, such as the geographical location of device 700, the speed at which the device 700 is moving, the temperature of device 700, and other suitable states, for example.

Similarly, device 700 includes smart phone services module 770, which is configured to provide conventional smart phone services, such as an operating system, application software, media players, and other suitable services, for example.

In the illustrated embodiment, device 700 also includes operational module 760. Generally, operational module 760 is the particular implementation of one or more embodiments as disclosed herein. For example, in one embodiment, module 760 is control software and device 700 is a target handset. In an alternate embodiment, module 760 is command software and device 700 is a control handset. In an alternate embodiment, module 760 includes both control software and command software. Generally, embodiments of operational module 760 are described in more detail below.

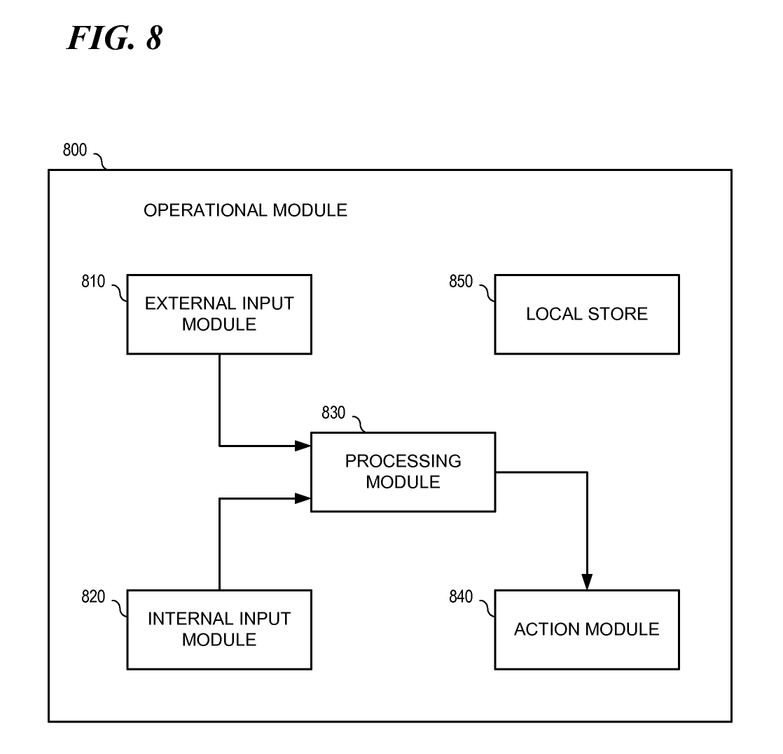

For example, FIG. 8 is a high-level block diagram illustrating an operational module 800, in accordance with one embodiment. Generally, module 800 illustrates the processing flow of a control module, in one embodiment. Module 800 includes external input module 810 and internal input module 820. Generally, external input module 810 receives and interprets input from external sensors 750. Similarly, internal input module 820 receives and interprets input from internal sensors 740.

In the illustrate embodiment, processing module 830 receives in put from external input module 810 and internal input module 820. Generally, processing module 830 evaluates received input to determine whether the received input indicates that the device 700 is in one of a number of predetermined device states. As described above, the predetermined device states represent manifestations of the configuration options selected by the control handset (or other administrative) user. For example, if the input from internal input module 820 indicates that the device user is attempting to write a text message, and the input from external input module 810 indicates that the device is currently located in a school zone, processing module 830 identifies the device as in the state “texting in a school zone”. Depending on the configuration options, this device state may be on a watch list.

For example, if the control handset user disallows “texting in a school zone”, processing module 830 watches for that device state. In the event that processing module 830 detects that device state, processing module 830 indicates as such to action module 840. Generally, action module 840 implements whatever predetermined actions the control handset user has selected as the response to attempted “texting in a school zone.”

For example, as described above, in one embodiment, the control handset user can choose to allow the text message to be saved on the target handset, but not transmitted from the target handset. In an alternate embodiment, the control handset user can elect to shut down the text message functions and display a message to the target handset user. In one embodiment, the predetermined action includes sending an alert to the control handset (and/or control handset user).

Thus, generally, operational module 800 watches for predetermined device states as indicated by input received about the current device state. In the event a predetermined device state is detected, module 800 performs one or more predetermined actions. In the illustrated embodiment, module 800 also includes a local store 850, configured to store, among other things, the watch list of device states and the predetermined actions, as well as other configuration information.

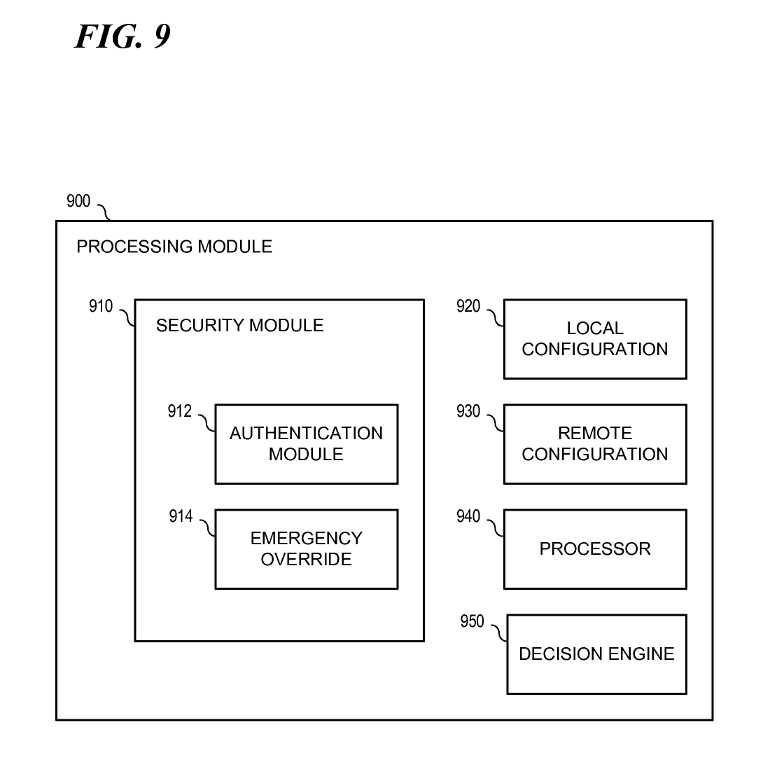

FIG. 9 is a high-level block diagram illustrating an exemplary processing module 900 of an operational module 800. In the illustrated embodiment, processing module 900 includes security module 910. Generally, security module 910 is configured to prevent unauthorized use of the target handset and to ensure emergency operation is always available. For example, in the illustrated embodiment, security module 910 includes authentication module 912. Generally, authentication module 912 is configured to ensure that the control software (and/or command software) is authentic and that only the authorized control handset user is permitted to uninstall, remove, or otherwise disable one or more features of the control software on the target handset.

Additionally, in the illustrated embodiment, security module 910 also includes emergency override module 914. Generally, module 914 is configured to ensure that emergency operations, such as dialing 911, for example, are not blocked when the control software blocks outgoing telephone calls. As such, module 914 improves the safety of the target handset by maintaining access to emergency operations, even when the ordinary features required to access those operations are otherwise disabled.

In the illustrated embodiment, processing module 900 also includes a local configuration module 920 and a remote configuration module 930. Generally, local configuration module 920 is configured to allow the target handset user to make whatever configuration changes are permitted to the target handset user by the control handset user. Additionally, in one embodiment, local configuration module 920 is configured to implement configuration changes on the device itself. Similarly, remote configuration module 930 is configured to allow a remote user (i.e., the control handset user) to make configuration changes on the target handset. As described above, in one embodiment, the configuration changes are initiated at a web site and pushed to the device by a regional server 350 (or mobile server 380). Additionally, in one embodiment, remote configuration module 930 is configured to implement configuration changes on the device itself.

As described above, processing module 900 monitors the device state to identify predetermined watch states. In the illustrated embodiment, processing module 900 includes a processor 940 and a decision engine 950. In one embodiment, processor 940 is configured to perform the necessary operations to identify when the device is in a predetermined watch list device state.

In one embodiment, processing module 900 notifies the action module of the device state. In an alternate embodiment, decision engine 950 is configured to identify which actions, if any, are required based on the identified device state. As such, in one embodiment, processor 940 identifies the device state, whether on the watch list or not, and decision engine 950 determines whether that device state triggers a predetermined operation. In one embodiment, decision engine identifies a predetermined operation, and directs, in the form of issued commands, the action module to perform the predetermined operation.

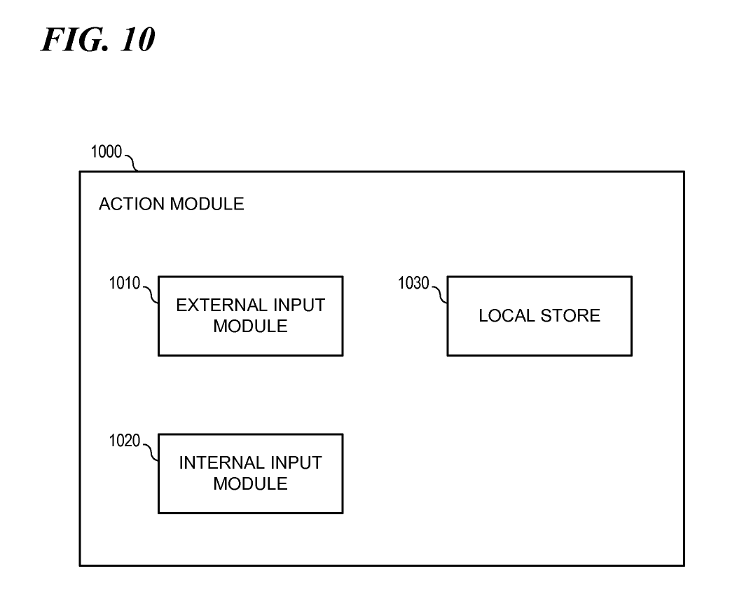

FIG. 10 is a high-level block diagram of an action module 1000 of an operational module 800. As described above, in one embodiment, action module 1000 receives direction and/or commands to perform one or more predetermined operations, generally in response to identified watch list device states. In the illustrated embodiment, action module 1000 includes external input module 1010. Generally, external input module 1010 is configured to execute whatever operations are required to interact with entities outside of the device. For example, in one embodiment, external input module 1010 is configured to send text/SMS message alerts, send email, send other reports and perform other suitable operations in support of a predetermined operation.

Similarly, in the illustrated embodiment, action module 1000 includes internal input module 1020. Generally, internal input module 1020 is configured to execute whatever operations are required to modify the device state as is possible using internal device controls. For example, in one embodiment, internal input module 1020 is configured to block access to GUIs, applications, telephone interfaces, and other suitable features in support of a predetermined operation.

As describe above, some of the disclosed embodiments improve device operational safety by ensuring access to emergency features. In the illustrated embodiment, action module 1000 includes emergency module 1030. Generally, emergency module 1030 is configured to perform emergency services, such as connecting with 911 services, sending alerts to law enforcement, sending information to third-party security companies, and other suitable operations.

Accordingly, the disclosed embodiments provide numerous advantages over other methods and systems. For example, as smart phones have reached an all time high in popularity and use, the increased distraction has exploded. From a corporate point of view, this distraction, when engaged on company time, has created a risk and exposure for the corporation. Generally, corporations should take active steps to ensure that employees are acting responsible and look to systems to enforce their policies. The disclosed embodiments provide greatly improved granular control over individual mobile communication devices and their features, which improves their operational safety.

Other modifications and implementations will occur to those skilled in the art without departing from the spirit and scope of the invention as claimed. Accordingly, the above description is not intended to limit the invention except as indicated in the following claims.

What is claimed is:

1. A system for improving safe operation of mobile communication devices, comprising:
an operational module installable on a mobile communication device;
the mobile communication device able to communicate wirelessly over a mobile communications network, the mobile communication device having a plurality of internal sensors, a plurality of external sensors, a user interface, and a plurality of communications modules;
the operational module able to monitor at least one of the plurality of internal sensors and at least one of the plurality of external sensors, to determine whether the mobile communication device state is one of a plurality of predetermined device states, the predetermined device states representing predetermined watch list operations;
the predetermined watch list operations being determined based on improving the safe operation of the mobile communications device;
the operational module further able to execute predetermined operations in the event the mobile communication device state is one of the plurality of predetermined device states; and
the predetermined operations including controlling operation of the user interface and at least one of the plurality of communications modules.

2. The system of claim 1, wherein one of the predetermined device states indicates that the mobile communications device is in motion at or above a predetermined speed.

3. The system of claim 1, wherein one of the predetermined device states indicates that the mobile communications device is located within a school zone.

4. The system of claim 1, wherein one of the predetermined device states indicates that the mobile communications device is in a motor vehicle that is being driven in a manner predetermined as dangerous.

5. The system of claim 1, wherein one of the predetermined operations includes blocking text messaging and SMS applications from accessing the user interface.

6. The system of claim 1, wherein one of the predetermined operations includes blocking the mobile communication device from accepting incoming telephone calls.

7. The system of claim 1, wherein one of the predetermined operations includes blocking incoming the mobile communication device from accepting incoming text and SMS messages.

8. The system of claim 1, wherein one of the predetermined operations includes transmitting a message to a server, requesting that the server block text and SMS messages destined for the mobile communication device.

9. The system of claim 1, wherein one of the predetermined operations includes reporting the mobile device state to a control device.

10. The system of claim 1, wherein one of the predetermined operations includes reporting the mobile device state to a law enforcement agency.

11. The system of claim 1, the operational module further comprising a security module, the security module able to execute emergency override operations.

12. The system of claim 11, wherein the emergency override operations are based on the mobile communication device state.

13. The system of claim 11, wherein one of the emergency override operations includes reporting the mobile device state to a law enforcement agency.

14. A method for improving safe operation of mobile communication devices, comprising:
running an operational module installed on a mobile communication device;
the mobile communication device able to communicate wirelessly over a mobile communications network, the mobile communication device having a plurality of internal sensors, a plurality of external sensors, a user interface, and a plurality of communications modules;
monitoring at least one of the plurality of internal sensors and at least one of the plurality of external sensors, to determine whether the mobile communication device state is one of a plurality of predetermined device states, the predetermined device states representing predetermined watch list operations;
the predetermined watch list operations being determined based on improving the safe operation of the mobile communications device;
executing at least one predetermined operation in the event the mobile communication device state is one of the plurality of predetermined device states; and
the predetermined operations including controlling operation of the user interface and at least one of the plurality of communications modules.

15. The method of claim 14, wherein one of the predetermined device states indicates that the mobile communication device is in operation during a predetermined time of day.

16. The method of claim 14, wherein:
one of the predetermined device states indicates that the mobile communication device has received an electronic image; and
one of the predetermined operations includes restricting the received electronic image to a password-protected storage location on the mobile communication device.

17. The method of claim 14, wherein one of the predetermined operations includes blocking telephone calls based on a comparison of a caller ID of the telephone call with a list of restricted numbers.

18. A computer program product for improving safe operation of mobile communication devices, the computer program product stored on a computer usable storage medium having computer usable program code embodied thereon, the computer usable program code comprising:
computer usable program code configured to launch an operational module installed on a mobile communication device;
the mobile communication device able to communicate wirelessly over a mobile communications network, the mobile communication device having a plurality of internal sensors, a plurality of external sensors, a user interface, and a plurality of communications modules;
computer usable program code configured to monitor at least one of the plurality of internal sensors and at least one of the plurality of external sensors, to determine whether the mobile communication device state is one of a plurality of predetermined device states, the predetermined device states representing predetermined watch list operations;
the predetermined watch list operations being determined based on improving the safe operation of the mobile communications device;
computer usable program code configured to execute predetermined operations in the event the mobile communication device state is one of the plurality of predetermined device states; and
the predetermined operations including controlling operation of the user interface and at least one of the plurality of communications modules.

19. The computer program product of claim 18, wherein one of the predetermined device states indicates that the mobile communication device has moved out of a predetermined geographic area.

20. The computer program product of claim 18, wherein one of the predetermined operations includes blocking Internet access to and from the mobile communication device.
